(19) United States
(12) Patent Application Publication
(10) Pub. No.: US 2019/0279138 A1
(43) Pub. Date: Sep. 12, 2019

(54) INFORMATION PROCESSING DEVICE

(71) Applicant: Toyota Jidosha Kabushiki Kaisha, Toyota-shi Aichi-ken (JP)

(72) Inventors: Ko Koga, Setagaya-ku Tokyo (JP); Hiroki Awano, Nerima-ku Toyko (JP); Keiko Suzuki, Suginami-ku Tokyo (JP); Toshiki Endo, Shiki-shi Saitama-ken (JP)

(73) Assignee: Toyota Jidosha Kabushiki Kaisha, Toyota-shi Aichi-ken (JP)

(21) Appl. No.: 16/293,776

(22) Filed: Mar. 6, 2019

(30) Foreign Application Priority Data
Mar. 12, 2018 (JP) 2018-044450

(51) Int. Cl. G06Q 10/06; G06Q 10/10; G06F 9/54

(52) U.S. Cl. CPC G06Q 10/063114; G06F 9/542; G06Q 10/1097

(57) ABSTRACT

An information processing device includes a processor. The processor is configured to acquire schedule information of a user including at least a start time, acquire information on tasks associated with the schedule information of the user, the tasks being a plurality of tasks to be completed by the start time, acquire a degree of task achievement that is a degree of achievement of the tasks, based on an implementation situation of each task, acquire an index value regarding forgetting about the task of the user, the index value being a forgetting index value that is calculated according to a remaining time until the start time, and decide whether or not the user has forgotten about the implementation of the task based on the acquired degree of task achievement and the acquired forgetting index value.

### CROSS-REFERENCE TO RELATED APPLICATION

This application claims priority to Japanese Patent Application No. 2018-044450 filed on Mar. 12, 2018, incorporated herein by reference in its entirety.

### BACKGROUND

### 1. Technical Field

The present disclosure relates to an information processing device that supports a user behavior.

### 2. Description of Related Art

Japanese Unexamined Patent Application Publication No. 2014-211821 (JP 2014-211821 A) discloses an information processing device that notifies of approach of a schedule to be performed for a conference or the like, which is an information processing device that controls a timing at which the information processing device notifies of the approach of the schedule to be performed according to a performance situation of a past similar schedule similar to the schedule to be performed.

### SUMMARY

JP 2014-211821 A proposes a technique of reminding a user to be in time for a start time when a user seems to be late for a start time of a conference or the like. In the above technique, behavior support is performed so that the user arrives at a scheduled place by the start time. However, in a case where the user has to prepare materials to be used for the conference, behavior support regarding material creation by a conference start time is not performed.

In general, a schedule to be written to a schedule book includes a time, a place, content, and the like. In the presence of various types of schedules, such as a conference schedule at a company and a schedule of dinner with a friend at private, various tasks or actions to be implemented occur for the user before a start time of many schedules. For example, when a conference schedule is set, a user has to complete various tasks, such as discussing in a team until the day of the conference, creating materials, and sending the created materials to parties concerned. Further, when there is a contact from a friend when a user is at home on a holiday, and the user will meet the friend at a restaurant at 18 o'clock on that day, various actions to be implemented occur before the user goes to the restaurant occurs, such as taking a shower or changing clothes, for the user.

The present disclosure provides an information processing device that performs behavior support so that a user does not forget to implement a task or an action when there is a task to be completed or an action to be implemented by a start time of the schedule.

An aspect of the present disclosure relates to an information processing device including a processor. The processor is configured to acquire schedule information of a user including at least a start time, acquire information on tasks associated with the schedule information of the user, the tasks being a plurality of tasks to be completed by the start time, acquire a degree of task achievement that is a degree of achievement of the tasks, based on an implementation situation of each task, acquire an index value regarding forgetting about the task of the user, the index value being a forgetting index value that is calculated according to a remaining time until the start time, and decide whether or not the user has forgotten about the implementation of the task based on the acquired degree of task achievement and the acquired forgetting index value.

According to the aspect, by deciding the forgetting about the implementation of the task based on the degree of task achievement and the forgetting index value, the user can implement the task after the decision is made that the task implementation has been forgotten, and complete the task in time until the start time of the schedule.

In the information processing device according to the aspect, the processor may be further configured to acquire the implementation situation of each task, and configured to estimate the implementation situation of the task from a situation of the user. According to the above aspect, it is possible to improve reliability of the degree of task achievement by estimating the task implementation situation from the situation of the user.

In the information processing device according to the aspect, the processor may be configured to decide the situation of the user based on position information of the user or a use situation of a device of the user.

In the information processing device according to the aspect, the processor may be configured to notify the user of information on the schedule when the processor decides that the user has forgotten about the implementation of the task. According to the aspect, it is possible to notify the user of the forgetting about the implementation of the task.

In the information processing device according to the aspect, the processor may be configured to acquire a forgetting threshold value that is calculated according to a time from an occurrence time of the task to a start time of the schedule and a remaining time from a certain time after the task occurrence time to the start time of the schedule as the forgetting index value, compare the degree of task achievement with the forgetting threshold value, and decide that the user has forgotten about the implementation of the task when the forgetting threshold value is greater than the degree of task achievement.

In the information processing device according to the aspect, the processor may be configured to calculate the degree of task achievement based on a degree of importance set in the task and the implementation situation of the task.

According to the aspect of the present disclosure, it is possible to provide a technique for supporting the implementation of the task associated with the schedule information of the user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of an information processing system according to an embodiment;

FIG. 2 is a diagram illustrating an example of a task setting screen;

FIG. 3 is a diagram illustrating functional blocks of an information processing device;

FIG. 4 is a diagram illustrating a task table;

FIG. 5 is a graph showing an example of a forgetting index curve;

FIG. 6 is a graph showing an example of the forgetting index curve;

FIG. 7 is a graph showing an example of a relationship between a degree of task achievement and a forgetting index curve; and

FIG. 8 is a flowchart for supporting task implementation of a user.

### DETAILED DESCRIPTION

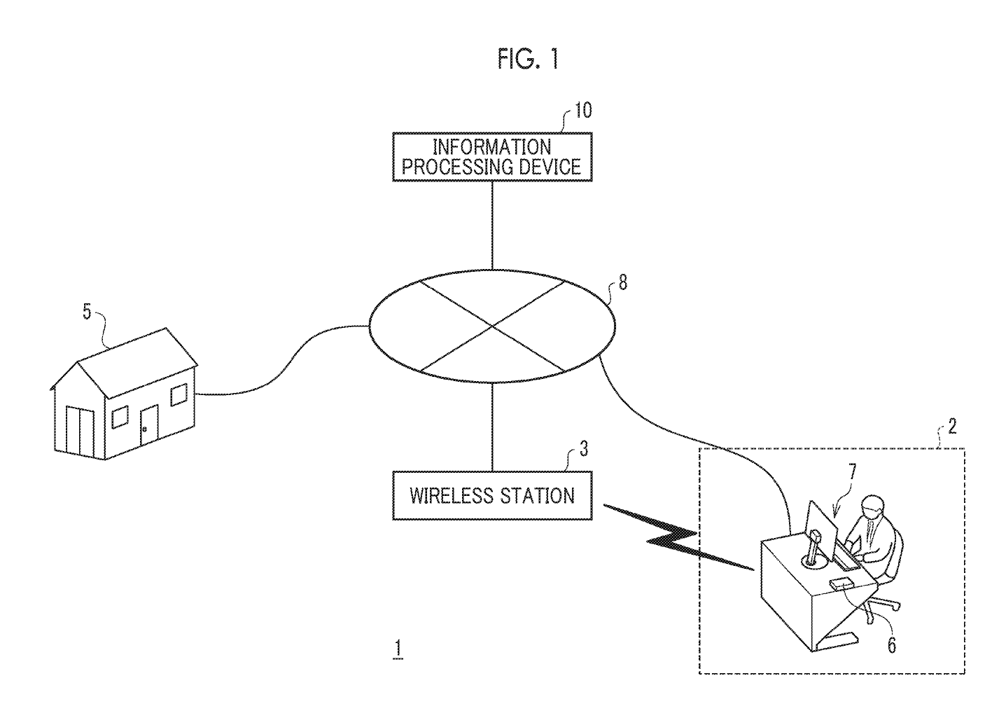

FIG. 1 illustrates a schematic configuration of an information processing system 1 according to an embodiment. The information processing system 1 is a system that supports execution of a task or an action (hereinafter referred to as a “task”) associated with a schedule of a user, and includes an information processing device 10 connected to a network 8 such as the Internet. The information processing device 10 is, for example, a server device installed in a data center, and realizes a task implementation support function according to the schedule of the user.

In FIG. 1, a state in which the user is working using a personal computer (hereinafter referred to as a “PC (Personal Computer)”) 7 in a workplace 2 is illustrated. A mobile terminal 6 placed on a desk is a terminal device that can be carried by the user, such as a smartphone or tablet having a wireless communication function. The PC 7 is connected to the network 8 via a router installed in the workplace 2, and the mobile terminal 6 is connected to the network 8 via a wireless station 3 which is a base station. Further, a router is installed at a home 5 of the user, and various devices in the home 5 are connected to the network 8. The information processing device 10 acquires various types of information on the user from various devices in the home 5, various devices including the PC 7 in the workplace 2, the mobile terminal 6, and the like.

At least one of the mobile terminal 6 and the PC 7 executes an application (hereinafter also referred to as a “scheduler”) that manages the schedule of the user. When a start time of the schedule registered in a schedule book comes, the scheduler notifies the user of that fact through pop-up display or the like. The scheduler synchronizes schedule information of the user including at least a schedule ID (Identification) for identifying a schedule and the start time of the schedule with the information processing device 10, and the information processing device 10 manages the latest schedule information of the user.

Further, at least one of the mobile terminal 6 and the PC 7 executes an application (hereinafter also referred to as a “task setting application”) that sets information on a task associated with the schedule information of the user, which is a task to be completed by the start time of the schedule. The task setting application synchronizes the information on the task with the information processing device 10, and the information processing device 10 manages the task associated with the schedule information of the user.

Thus, the information processing device 10 acquires the schedule information of the user and the information on the task associated with the schedule information of the user. In the embodiment, the information processing device 10 acquires task information from the task setting application that is executed on at least one of the mobile terminal 6 and the PC 7. In another example, the information processing device 10 may acquire information on a task associated with past schedule information from a user behavior analysis tool or the like.

In the embodiment, a case where the information processing device 10 supports implementation of a plurality of tasks occurred for user A will be described. Here, in a conference with a client that user A has participated with other members, a scene in which a new proposal for a project has been requested before the next conference is assumed, and user A has to complete a plurality of tasks to be exemplified below until the next conference starts. Task A1: To create proceedings, Task A2: In-team meeting for a proposal at the next conference, Task A3: To create proposal materials at the next conference, Task A4: To reserve a conference room, Task A5: Customer registration of a person in charge of client, Task A6: To send proposal materials in advance, and Task A7: To develop information for next meeting.

When a team is formed of a plurality of members (users), tasks that have to be implemented until the next conference are different for each member according to their positions, job titles, or the like. Tasks A1 to A7 described above are tasks allocated to user A, but in-team meeting of task A2 among the tasks is a task common to other members in the team and the creation of materials of task A3 may be shared and implemented by a plurality of members. On the other hand, for example, tasks A4 to A7 are tasks that are often left to the young members who are low in job title, and one member may be in charge of tasks A4 to A7.

A task for information collection for a meeting in the team may be allocated to other members in the team, and a task for confirmation of proposal materials created by user A may be allocated to the other members. The schedule itself of the next conference is common to the members in the team as described above, but tasks allocated for the next conference are generally different for each member.

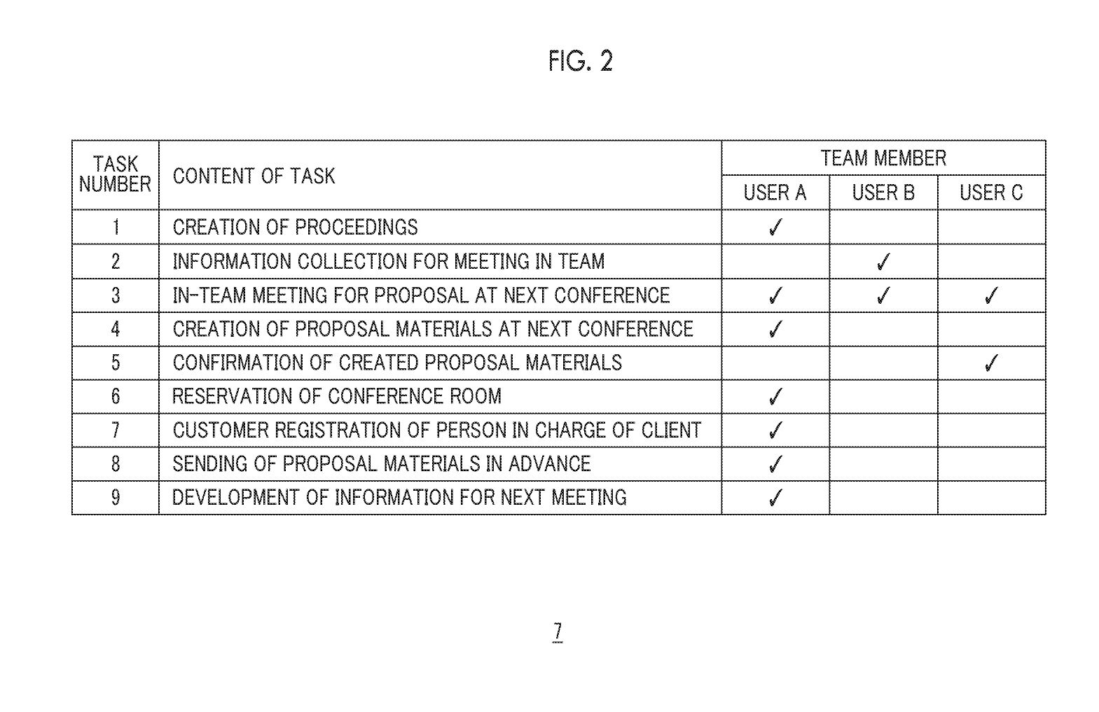

FIG. 2 illustrates an example of a task setting screen to be completed by a start time of the next conference. In a team including users A, B, C, user C who is a team leader executes the task setting application on the PC 7, extracts the tasks to be completed by the next conference, and distributes the respective tasks to the respective members. For the extraction of the tasks, user C may input text to an item “Content of task” on the task setting screen, and user C may select the tasks from a list defined as a task set for conference in the task setting application. In this example, tasks with task numbers 1 to 9 are extracted as tasks to be allocated for the next conference. User C may open the task setting screen on the PC 7, but user C may open the task setting screen on the mobile terminal 6 and distribute the tasks from the mobile terminal 6.

When the distribution of the tasks by user C is completed, the task setting application notifies at least one of the mobile terminal 6 and the PC 7 of users A, B of the information on the allocated tasks. Accordingly, each user recognizes the task allocated to the user and tries to complete the task by the start time of the next conference. Further, the task setting application acquires the schedule ID for identifying the schedule of the next conference from the scheduler, and transmits the content of the task and information on the person in charge of the task together with the schedule ID to the information processing device 10.

Although the above is an example in which user C who is a team leader distributes tasks to the respective users, each of users A, B, C may select his or her own task by checking the task on the task setting screen. Tasks defined as a task set for conference may be displayed in a list on the task setting screen, and each of users A, B, C may check his or her own task by checking the task. In this case, after the task selection by all the members ends, it is desirable for user C who is a team leader to confirm whether there is any leaked task among the tasks to be completed by the next conference.

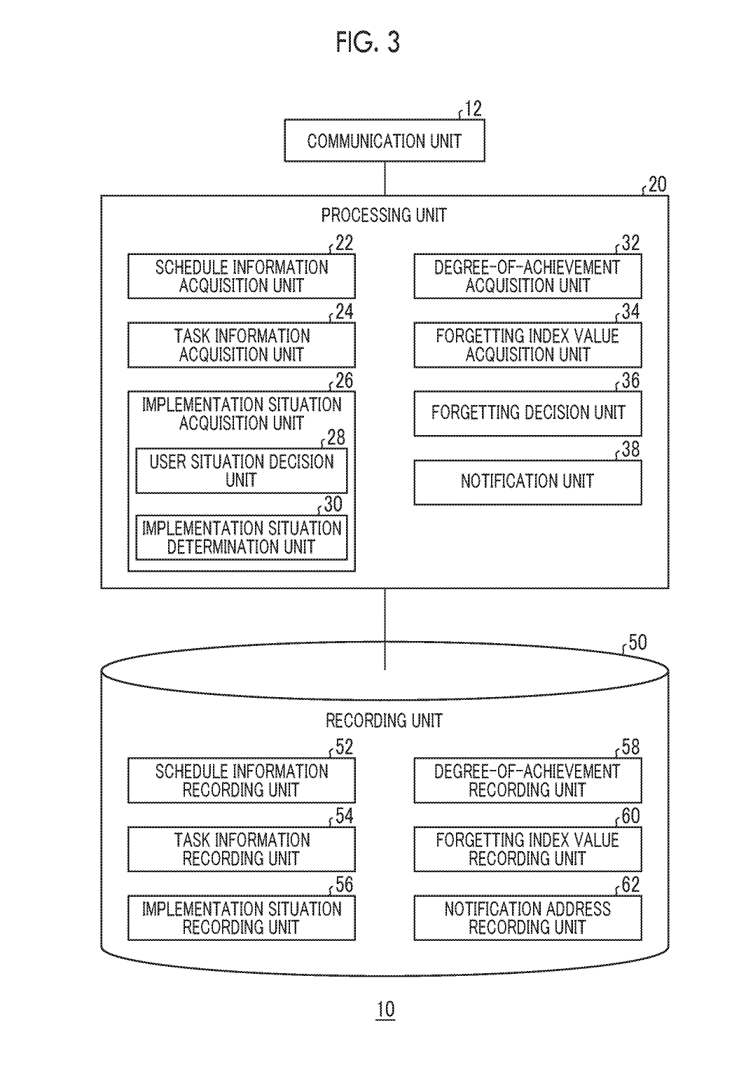

FIG. 3 illustrates functional blocks of the information processing device 10. The information processing device 10 includes a communication unit 12, a processing unit 20, and a recording unit 50. The communication unit 12 is a communication module that transmits and receives data or information to or from communication devices that are connected to the network 8 and, specifically, various devices in the home 5, various devices including the PC 7 in the workplace 2, and the mobile terminal 6.

The processing unit 20 is configured of a processor such as a central processing unit (CPU) and includes a schedule information acquisition unit 22, a task information acquisition unit 24, an implementation situation acquisition unit 26, a degree-of-achievement acquisition unit 32, a forgetting index value acquisition unit 34, a forgetting decision unit 36, and a notification unit 38. The implementation situation acquisition unit 26 has a user situation decision unit 28 and an implementation situation determination unit 30. The recording unit 50 includes a schedule information recording unit 52, a task information recording unit 54, an implementation situation recording unit 56, a degree-of-achievement recording unit 58, a forgetting index value recording unit 60, and a notification address recording unit 62.

Various functions illustrated in FIG. 3 can be realized by hardware such as a circuit block, a memory, and another large scale integration (LSI), and can be realized by software such as system software, or an application program loaded in a memory. Therefore, it is understood by those skilled in the art that such functions can be realized in various ways in the processing unit 20 by solely hardware, solely software, or a combination thereof, and are not limited to any one of the forms.

The schedule information acquisition unit 22 acquires the schedule information of the user. The schedule information includes at least a schedule ID for identifying a schedule and a schedule start time. Although it is desirable for the start time to be information capable of specifying a date and time of the start, for example, in a schedule for a few months later, temporarily a time may not be determined and solely a date may be determined. Therefore, in a schedule in which solely a date is determined, a start time is a predetermined time (for example, 0 o'clock) in one day, and the schedule information acquisition unit 22 acquires the schedule information of the user. Similarly, for example, in a schedule for a few years later, a day may not be determined and solely a month may be determined. In this case, a start time is a predetermined time (for example, 0 o'clock) in a predetermined day in the month (for example, one day at the beginning of the month). The schedule information acquisition unit 22 may acquire the schedule information of the user. The schedule information acquisition unit 22 acquires the schedule information of the user from the scheduler that is executed by the mobile terminal 6 or the PC 7 of the user and records the schedule information in the schedule information recording unit 52.

The task information acquisition unit 24 acquires information on tasks associated with the schedule information of the user, which are a plurality of tasks to be completed by the start time. The task information acquisition unit 24 acquires the information of the task associated with the schedule information of the user from the task setting application that is executed by the mobile terminal 6 or the PC 7 of the user and records the information in the task information recording unit 54. In the mobile terminal 6 or the PC 7, the task setting application may transmit the task information associated with the schedule information to the information processing device 10 together with the schedule information of the user. In this case, the schedule information acquisition unit 22 may acquire the schedule information of the user from the task setting application.

Hereinafter, a case where the information processing device 10 supports implementation of tasks A1 to A7 of user A will be described. The communication unit 12 receives information indicating a situation of user A from various devices including the PC 7 in the workplace 2, various devices in the home 5, the mobile terminal 6, or the like. The implementation situation acquisition unit 26 decides the situation of user A based on such information and estimates and acquires an implementation situation of the task from the decided situation of user A.

The user situation decision unit 28 decides the situation of user A based on position information of user A, use information of the device, and the like. Regarding the position information, the user situation decision unit 28 can specify a location of user A from GPS position information that is transmitted from the mobile terminal 6. When the position information of user A indicates the workplace 2, the user situation decision unit 28 decides that user A is in the workplace 2, and when the position information indicates the home 5, the user situation decision unit 28 decides that user A is at home 5. When the position information of user A is moving, the user situation decision unit 28 decides that user A is traveling on a vehicle or a train.

Even when the mobile terminal 6 does not transmit the GPS position information to the information processing device 10, the user situation decision unit 28 can specify the location of user A from the use information of a device. For example, the user situation decision unit 28 may decide that user A is at home 5 from information indicating that a home appliance such as a television at home 5 of user A is in use or that a water heater of a shower is in operation. Similarly, the user situation decision unit 28 may decide that user A is in the workplace 2 from information indicating that user A is logging in to the PC 7 in the workplace 2.

When the user situation decision unit 28 acquires the information indicating that user A is logging in to the PC 7 in the workplace 2, the user situation decision unit 28 decides that user A is working using the PC 7. When user A performs tasks regarding tasks A1 to A7, the task setting application may interlock to notify the information processing device 10 of the task ID which is identification information of the task to be implemented. Accordingly, the user situation decision unit 28 decides that user A is implementing a task specified by the task ID, and the implementation situation determination unit 30 decides that the task is implementing. Further, when user A completes the task, the task setting application notifies the information processing device 10 that user A has completed the task, such that the user situation decision unit 28 decides that user A has completed task and the implementation situation determination unit 30 decides that the task has been completed. Thus, it is desirable for the task setting application to be able to automatically notify the information processing device 10 of the task ID by interlocking with the operation of the PC 7 of the user.

When the task setting application does not have such an interlocking function, the user may activate the task setting application during the operation of the PC 7, input the implementation situation of the task, and cause the task setting application to transmit the task implementation situation to the information processing device 10. In addition to the task setting application, means for allowing the user to transfer the implementation situation of the task to the information processing device 10 may be prepared.

In this example, the implementation situation determination unit 30 receives the notification from the task setting application, determines the implementation situation of each task allocated to user A, and acquires the implementation situation. In the embodiment, the implementation situation determination unit 30 determines the implementation situation of the task in three stages including “not implemented”, “implementing”, and “completed”, and records the determined implementation situation in the implementation situation recording unit 56 for each task. When a plurality of tasks is allocated to user A, in other words, when the task information acquisition unit 24 acquires a plurality of pieces of task information and records the task information in the task information recording unit 54, the implementation situation of all the tasks is set to “not implemented” by default. Here, when user A starts “Creation of proceedings” which is task A1, the implementation situation determination unit 30 determines that the implementation situation of task A1 is “implementing” and, when the proceedings have been created, the implementation situation determination unit 30 determines that the implementation situation of task A1 is “completed”. Thus, the implementation situation of “Creation of proceedings” which is task A1 transitions to “not implemented”, “implementing”, and “completed” in this order by the start of the next conference.

On the other hand, for example, a task such as “customer registration” of task A5 does not consume a working time, and therefore, when the customer registration is performed, the implementation situation determination unit 30 determines that the implementation situation of task A5 is “completed”. Thus, according to the task, the implementation situation may change from “not implemented” to “completed”.

In the above example, regarding tasks A1 and A5, the implementation situation determination unit 30 determines the implementation situation of the task based on a notification from the task setting application or a self-report from user A. The implementation situation determination unit 30 may estimate the task implementation situation from the situation of the user decided by the user situation decision unit 28. For example, when the user situation decision unit 28 decides that user A is transmitting a mail with an attached file to participants of the next conference, the implementation situation determination unit 30 estimates that the implementation of “sending of materials” of task A6 has been completed and determines that the implementation situation of task A6 is “completed”. Thus, the implementation situation determination unit 30 may estimate the implementation situation of each task from the situation of the user decided by the user situation decision unit 28, and acquire the implementation situation. The implementation situation determination unit 30 records the acquired implementation situation of each task in the implementation situation recording unit 56.

The degree-of-achievement acquisition unit 32 acquires the degree of achievements of a plurality of tasks based on the implementation situation of each task recorded in the implementation situation recording unit 56. The degree of task achievement is calculated based on the degree of importance (I_{i,j}) set in each task and the implementation situation of each task. The degree of importance (Ii,ⱼ) set in each task is calculated from a ratio of an initial degree of importance (I_{ini_i,j}) of each task to a sum of the initial degrees of importance of all the tasks. i is an index for identifying the schedule of the next conference, and j is an index for identifying the task of user A in the next conference.

The degree of importance I_{i,j} of a task (j) is calculated using Equation (1) below.

$${I}_{i , j} = {I}_{ini\_i , j} / {\sum }_{j = 1}^{N} {I}_{ini\_ i , j} \qquad ( 1 )$$

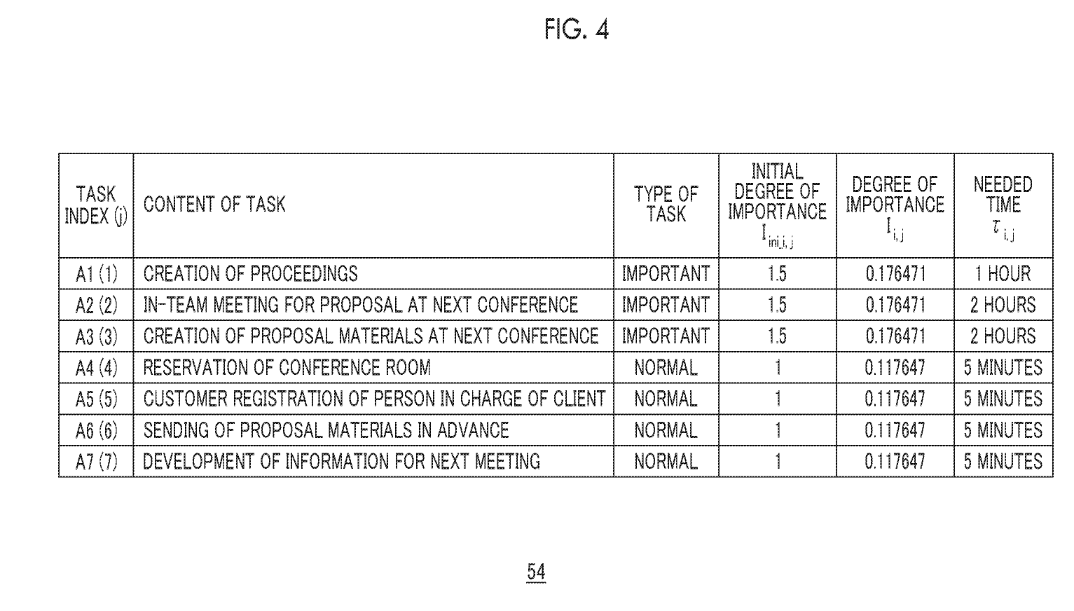

FIG. 4 illustrates a task table of user A recorded in the task information recording unit 54. The task table stores “content of task”, “type of task”, “initial degree of importance”, “degree of importance”, and “needed time” in association with the task index j. Content of the task allocated to user A is described in the “content of task”. Here, content of the seven tasks A1 to A7 set for user A in FIG. 2 is described.

In the task table of the embodiment, an “initial degree of importance I_{ini_i,j}” is set according to an item value of the “type of task”. In this example, the initial degree of importance 1 is associated with the type of task “normal”, and the initial degree of importance 1.5 is associated with the type of task “important”. The “type of task” may further include an item value of a “most important”, and the initial degree of importance 3 may be associated with the “most important”. The “needed time” is an implementation time of an expected task.

The example in which the task setting application executed on at least one of the mobile terminal 6 and the PC 7 transmits the schedule ID, the content of the task, and the information on the person in charge of the task to the information processing device 10 has been described, and in this case, the task setting application also transmits information on the type of task, the initial degree of importance, and needed time in association with the content of the task. The degree-of-achievement acquisition unit 32 calculates the degree of importance I_{i,j} of each task from Equation (1) by referring to the task information of the task information recording unit 54. The degree of importance I_{i,j} calculated by the degree-of-achievement acquisition unit 32 is included in the task table of FIG. 4.

The degree-of-achievement acquisition unit 32 calculates the degree of task achievement Aᵢ using the degree of importance of each task recorded in the task information recording unit 54 and the implementation situation of each task recorded in the implementation situation recording unit 56. The degree of task achievement Aᵢ is calculated by Equation (2) below.

$${A}_{i} = {\sum }_{j = 1}^{N} {a}_{i , j} \cdot {I}_{i , j} \qquad ( 2 )$$

Here, a coefficient a_{i,j} has a value according to the task implementation situation, and a_{i,j}×I_{i,j} denotes an individual degree of achievement of each task (j). For example, the coefficient a_{i,j} has the following value with respect to the task implementation situation. “Not implemented” a_{i,j}=0, “implementing” a_{i,j}=0.8, and “completed” a_{i,j}=1

When all the tasks are not implemented, the degree of task achievement Aᵢ is 0, and when all the tasks are completed, the degree of task achievement Aᵢ is 1. Therefore, user A has to implement each task so that the degree of task achievement Aᵢ becomes 1 before the start of the next conference.

The forgetting decision unit 36 has a function of deciding whether or not the user forgets about implementation of the task. The forgetting decision unit 36 may have two types of decision functions. One of the decision functions is a function of comparing the remaining time (t) up to the start time of the next conference with a total time (SUM_τ) of the needed time τ_{i,j} of an incomplete task, in which the notification unit 38 notifies the user of forgetting about task implement when the remaining time (t) reaches the total time (SUM_τ).

According to the decision function, when user A can use all of a time up to the schedule start after the reception of the notification to implement an incomplete task, the task can be theoretically completed in time for the start of the conference. However, since the needed time τ_{i,j} of the task that is a decision reference for a notification is solely an estimated value, an incomplete task is not completed by the scheduled start when an actual implementation time exceeds the needed time τ_{i,j}.

Therefore, the forgetting decision unit 36 according to the embodiment separately has a function of deciding that the user forgets amount implementation of the task before the remaining time (t) reaches the total time (SUM_τ). The forgetting decision unit 36 decides whether or not user A forgets about implementation of the task based on the degree of task achievement Aᵢ and the forgetting index value (Cᵢ(t)) which is an index value regarding the task forgetting of the user.

In order to realize the decision function of the forgetting decision unit 36, the forgetting index value acquisition unit 34 acquires the forgetting index value (Cᵢ(t)) that is calculated according to the remaining time until the start time, and records the forgetting index value (Cᵢ(t)) in the recording unit 60. In the embodiment, the forgetting index value (Cᵢ(t)) is calculated according to the time (T) from the occurrence time of the task to the start time of the schedule and the remaining time (t) from the certain time after the task occurrence time to the start time of the schedule. Here, the certain time may be a time (a current time) at which a forgetting decision is performed. The forgetting index value (Cᵢ(t)) represents a forgetting index indicating a degree of forgetting about the task of user A, and is a forgetting threshold value that is calculated for comparison with the degree of task achievement Aᵢ. The forgetting decision unit 36 compares the degree of task achievement Aᵢ with the forgetting index value (Cᵢ(t)), and decides that user A forgets about the implementation of the task when the forgetting index value (Cᵢ(t)) is greater.

The forgetting index value Cᵢ(t) is calculated using Equation (3) below.

$${C}_{i} ( t ) = 1 - {( \frac{t}{T} )}^{α} \qquad ( 3 )$$

As expressed in Equation (3), the forgetting index value Cᵢ(t) is calculated using the time (T) from the occurrence time of the task to the start time of the schedule, and the remaining time (t) from the certain time after the task occurrence time such as the current to the start time of the schedule. The parameter α may have a different value depending on the user and may be different depending on whether the user is of a type in which the user implements the task earlier or a type in which the user implements the task at a scheduled time. When the user is of a type in which the user implements the task earlier, the parameter α of the user may have a value greater than 1, and on the other hand, when the user is of a type in which the user implements the task at the scheduled time, the parameter α of that user may have a value smaller than 1.

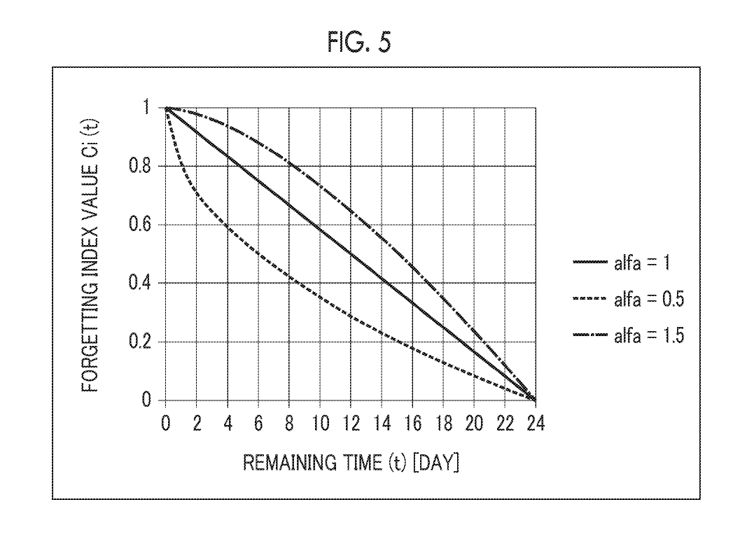

FIG. 5 illustrates an example of a forgetting index curve. In FIG. 5, a state in which time T from an occurrence time of a task to a start time of the schedule is set to “24 days”, and a forgetting index value that is a forgetting threshold value increases as remaining time t decreases is illustrated. When the forgetting index value is higher than the degree of task achievement, the forgetting decision unit 36 decides whether the user has forgotten about implementation of the task. When a plurality of tasks is allocated to user A, in other words, when the task information acquisition unit 24 acquires a plurality of pieces of task information and records the task information in the task information recording unit 54, the forgetting index value Cᵢ(t) is 0, and when the start time of the schedule comes and the remaining time becomes 0, the forgetting index value Cᵢ(t) is 1.

FIG. 5 illustrates a forgetting index value Cᵢ(t) in a case where the parameter α is 0.5, 1, 1.5. Since the parameter α is one factor for appropriately deciding forgetting about the task implementation of user A, it is desirable to specify whether user A is of type in which user A implements the task earlier or type in which user A implements the task at the scheduled time through machine learning of past task implementation situation of user A, and for an optimal parameter α according to user A to be derived.

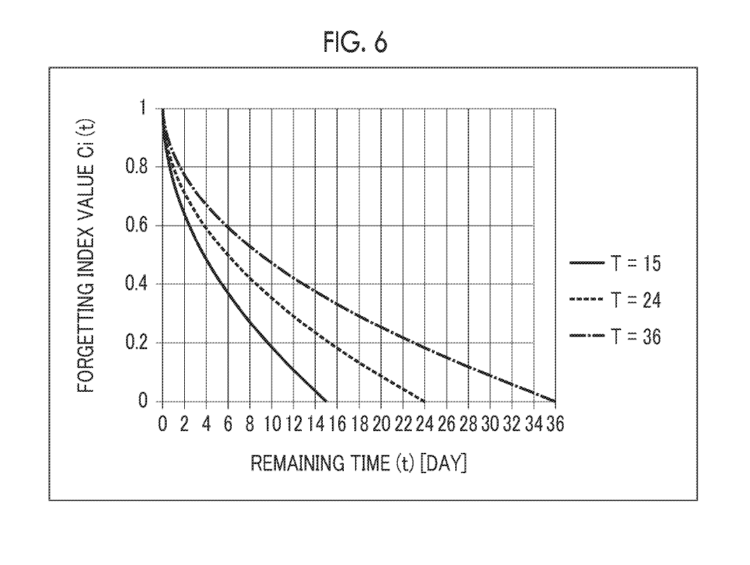

FIG. 6 illustrates an example of a forgetting index curve. In FIG. 6, the parameter α is unified to 0.5, and the forgetting index value Cᵢ(t) in a case where time T is 15 days, 24 days, and 36 days is illustrated. In the forgetting index curves illustrated in FIGS. 5 and 6, a horizontal axis is illustrated in units of “day” in order to represent the time until the next conference of user A, but the units on the horizontal axis may be appropriately set according to a period of time up to the schedule. For example, the horizontal axis may be in units of “week” or “month” or may be in units of “hour” or “minute”.

The forgetting decision unit 36 compares the degree of task achievement Aᵢ with the forgetting index value Cᵢ(t) at the remaining time t, and decides that user A forgets about the implementation of the task when the forgetting index value Cᵢ(t) is great.

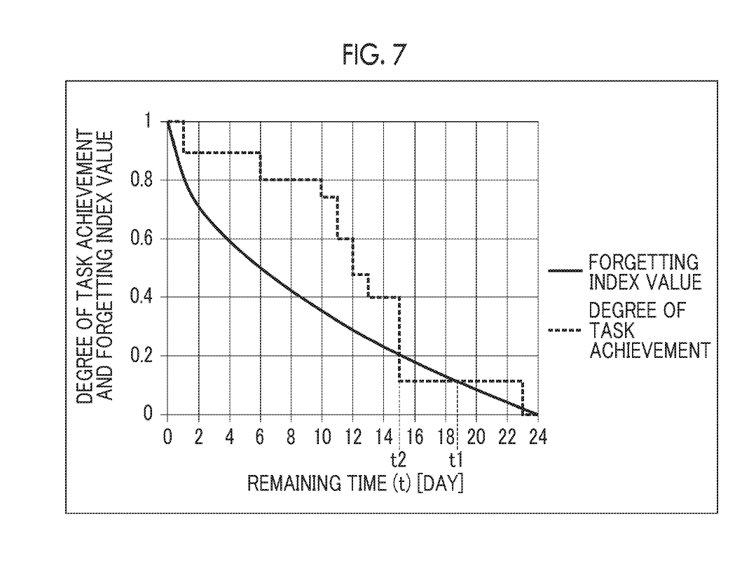

FIG. 7 illustrates an example of a relationship between the degree of task achievement and the forgetting index curve. In this example, when the remaining time is between t₁ and t₂, the degree of task achievement is below the forgetting index value. Therefore, the forgetting decision unit 36 decides that user A forgets about implementation of the task during a period from t₁ to t₂ of the remaining time.

When the task information acquisition unit 24 acquires the task information and records the task information in the task information recording unit 54, both the degree of task achievement Aᵢ and the forgetting index value Cᵢ(t) have a value of 0, but then, the forgetting index value Cᵢ(t) has a value greater than 0 as the remaining time t decreases. Therefore, a state in which the degree of task achievement is below the forgetting index value continues for a while from a point in time T as the remaining time. Therefore, the forgetting decision unit 36 may not perform the forgetting decision process when the remaining time is for a while from a point in time T, for example, when the remaining time is between T and 4T/5.

When the forgetting decision unit 36 decides that user A forgets about the implementation of the task, the notification unit 38 notifies user A of information on the schedule. The notification address recording unit 62 records a notification address of a communication device of user A, and the notification unit 38 notifies the information on the schedule as a message by referring to the notification address of user A. The information on the schedule may include a start date and time of the schedule and information indicating an incomplete task. It is desirable for the notification unit 38 to specify a communication device that is a notification destination using a situation of the user decided by the user situation decision unit 28. For example, when the user is working on the PC 7, the notification unit 38 may transmit a message to a mail address that can be viewed on the PC 7, and when the user is moving, the notification unit 38 may transmit a message to the mobile terminal 6.

Thus, user A can receive a reminder from the information processing device 10 when forgetting about the implementation of the task. Since the reminder is notified when the forgetting decision unit 36 decides forgetting about the implementation of the task based on the forgetting index value, user A can receive the reminder in a state in which there is still a time margin, and can regain an implementation delay of the task.

The above is a case in which forgetting about the implementation of the task is decided in a business scene, but the task implementation support according to the embodiment can be used in various scenes. For example, it is assumed that there is a contact from a friend when user A is relaxing at home on a holiday, and user A will meet the friend at a restaurant at 18 o'clock on that day. In this case, a plurality of tasks exemplified below occurs for user A. Task A11: To take a shower, Task A12: To change a cloth, Task A13: To prepare belongings, Task A14: Walk to the nearest station, Task A15: To withdraw a cash at a bank, Task A16: To move by train, Task A17: To walk to a restaurant after getting off.

When user A writes a meal schedule from 18 o'clock to a schedule book, the schedule information acquisition unit 22 acquires information on the meal schedule from 18 o'clock, and the task information acquisition unit 24 acquires information on tasks A11 to A17.

The task information acquisition unit 24 may acquire a plurality of tasks associated with the past schedule of “meal at restaurant” of user A using a behavior analysis tool in advance. The user situation decision unit 28 constantly acquires various pieces of information on the user, but the behavior analysis tool analyzes what behavior pattern user A has taken in the past about the schedule of “meal at the restaurant” using the information in advance. As a result, user A implementing actions of tasks A11 to A17 before the meal at the restaurant can be ascertained, and the task information acquisition unit 24 can acquire each action of the behavior pattern as a task.

Therefore, the forgetting decision unit 36 can decide whether or not the user has forgotten about the implementation of the task based on the degree of task achievement and the forgetting index value, and can support task implementation behaviors of the user, similar to an example of a conference in a business scene.

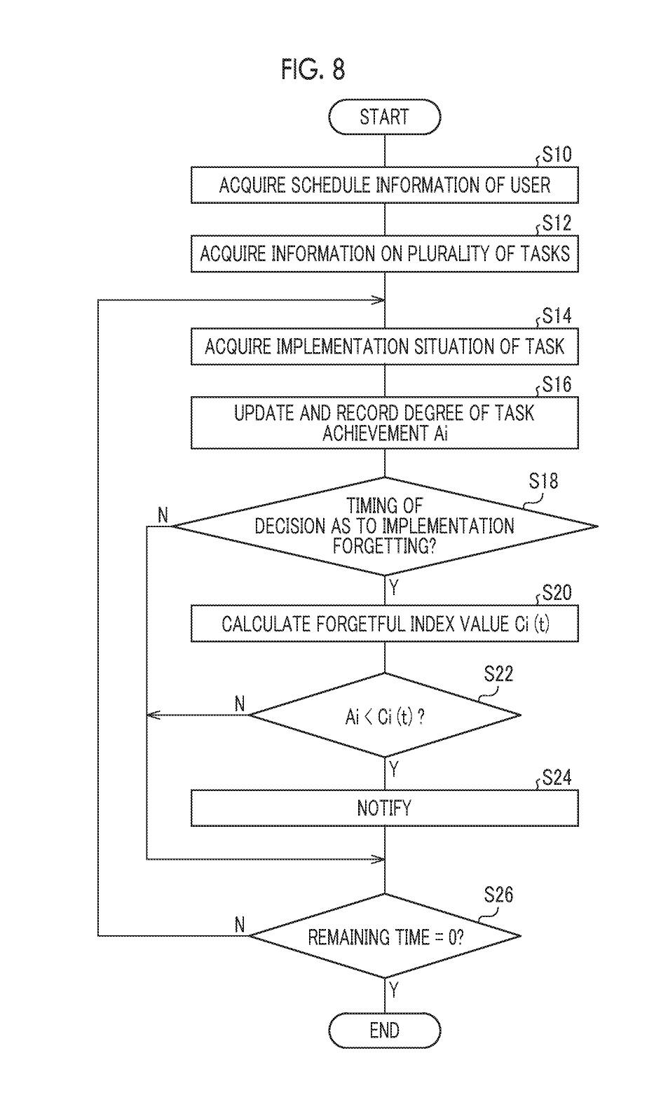

FIG. 8 illustrates a flowchart for supporting task implementation of the user. The schedule information acquisition unit 22 acquires the schedule information of the user including at least the start time (S10), and the task information acquisition unit 24 acquires information on tasks associated with the schedule information of the user, which are a plurality of tasks to be completed by the start time (S12).

The implementation situation acquisition unit 26 acquires various types of information on the user and acquires the implementation situation of each task (S14). The degree-of-achievement acquisition unit 32 acquires the degree of achievement Aᵢ of a plurality of tasks based on the implementation situation of each task and records the degree of achievement in the degree-of-achievement recording unit 58. When there is a change in the implementation situation of each task, the degree-of-achievement acquisition unit 32 updates the degree of task achievement Aᵢ and records the degree of task achievement Aᵢ in the degree-of-achievement recording unit 58 (S16). Accordingly, the latest degree of task achievement Aᵢ is recorded in the degree-of-achievement recording unit 58.

The forgetting decision unit 36 monitors whether a current time is a timing of a decision as to implementation forgetting about the task (S18). The decision timing is set in advance according to a period of time from the timing at which the schedule information has been acquired at S10 to the start time of the schedule. For example, in a case where this period of time is several months, the process of deciding forgetting about the implementation of the task may be executed about once a week, and in a case where the period of time is several weeks, the process of deciding forgetting about the implementation of the task may be executed at a time determined every day. When the current time is not the decision timing (N in S18), a decision is made whether or not the remaining time until the start time of the schedule is 0 (S26). When the remaining time is not 0 (N in S26), the process returns to step S14.

When the current time is the decision timing (Y in S18), the forgetting index value acquisition unit 34 calculates the forgetting index value Cᵢ(t) using the remaining time t from the current time (S20), and the forgetting decision unit 36 compares the degree of task achievement Aᵢ with the forgetting index value Cᵢ(t) (S22). In this case, when the forgetting index value Cᵢ(t) is greater than the degree of task achievement Aᵢ (Y in S22), the forgetting decision unit 36 decides that the user forgets about the implementation of the task, and the notification unit 38 notifies the user of the information on the schedule (S24). On the other hand, when the degree of task achievement Aᵢ is equal to or greater than the forgetting index value Cᵢ(t) (N in S22), the forgetting decision unit 36 decides that the user has not forgotten the implementation of the task. A task implementation support process of the user is continued until the remaining time becomes 0 (Y in S26).

The present disclosure has been described above based on the embodiment. It is to be understood by those skilled in the art that the embodiment is merely an example, various modification examples are possible for a combination of the respective components or the respective processes, and such modification examples are also within the scope of the present disclosure.

What is claimed is:

1. An information processing device comprising a processor configured to
acquire schedule information of a user including at least a start time,
acquire information on tasks associated with the schedule information of the user, the tasks being a plurality of tasks to be completed by the start time,
acquire a degree of task achievement that is a degree of achievement of the tasks, based on an implementation situation of each task,
acquire an index value regarding forgetting about the task of the user, the index value being a forgetting index value that is calculated according to a remaining time until the start time, and
decide whether or not the user has forgotten about the implementation of the task based on the acquired degree of task achievement and the acquired forgetting index value.

2. The information processing device according to claim 1, wherein the processor is further configured to acquire the implementation situation of each task, and configured to estimate the implementation situation of the task from a situation of the user.

3. The information processing device according to claim 2, wherein the processor is configured to decide the situation of the user based on position information of the user or a use situation of a device of the user.

4. The information processing device according to claim 1, wherein the processor is configured to notify the user of information on the schedule when the processor decides that the user has forgotten about the implementation of the task.

5. The information processing device according to claim 1, wherein the processor is configured to acquire a forgetting threshold value that is calculated according to a time from an occurrence time of the task to a start time of the schedule and a remaining time from a certain time after the task occurrence time to the start time of the schedule, as the forgetting index value, compare the degree of task achievement with the forgetting threshold value, and decide that the user has forgotten about the implementation of the task when the forgetting threshold value is greater than the degree of task achievement.

6. The information processing device according to claim 1, wherein the processor is configured to calculate the degree of task achievement based on a degree of importance set in the task and the implementation situation of the task.
